(19) United States
(12) Patent Application Publication
(10) Pub. No.: US 2009/0219488 A1
(43) Pub. Date: Sep. 3, 2009

(54) Diode or Laser Light Source Illumination Systems

(76) Inventor: Oliver Cristian Matthias Dufour, Frederiksberg (DK)

Correspondence Address: CROCKETT & CROCKETT, P.C., 26020 ACERO, SUITE 200, MISSION VIEJO, CA, 92691, US

(21) Appl. No.: 12/093,494

(22) PCT Filed: Nov. 13, 2006
(86) PCT No.: PCT/DK2006/000626

§ 371 Date: Oct. 10, 2008

Related U.S. Application Data
(60) Provisional application No. 60/736,396, filed on Nov. 14, 2005.
(60) Provisional application No. 60/758,484, filed on Jan. 12, 2006.
(60) Provisional application No. 60/777,864, filed on Mar. 1, 2006.

(51) Int. Cl. G03B 21/14; F21V 9/00

(52) U.S. Cl. 353/20; 362/231

(57) ABSTRACT

There is provided a first illumination system having at least three diode and/or laser light sources including a red, a green and a blue light source. The first illumination system further has at least three polarizing light converting elements corresponding to each colour of light sources, at least three liquid crystal panels corresponding to each colour of light sources, and at least one prism arrangement. There is also provided a light source module having at least a first diode or laser light source providing light in the visible range, at least a second light source comprising an UV (ultra-violet) or a low wavelength blue diode or laser light source, and a beam splitter or reflection system.

### FIELD OF THE INVENTION

The present invention relates to diode or laser light source illumination systems, and more particularly to an illumination system having red, green and blue diode and/or laser light sources.

### BACKGROUND OF THE INVENTION

Light emitting diodes (LED) are commonly used as a light source for an image projecting apparatus or projector, because of its properties of reduced power consumption and heat release, decreased dimensions, and extended lifetime.

In the field of liquid crystal projectors, a liquid crystal projector has been proposed in Japanese Patent Laid-Open Publication No. 2002-244211. In the liquid crystal projector, a liquid crystal panel has to be illuminated with linear polarization, and for the proposed projection device there are three LED array light sources corresponding to light sources of red, green, and blue, which are arranged so as have the diode light outputs being directed through three corresponding polarized light converting elements into a dichroic prism, where the resulting light beam being output from the prism is directed to a liquid crystal panel via a polarizing beam splitter, and the light beam is then reflected from the liquid crystal panel through the polarizing beam splitter via a projection lens enabling a projection of the light beams modulated on the liquid crystal panel onto a screen.

Thus, the image projection device described in Japanese Patent Laid-Open Publication No. 2002-244211 uses a single liquid crystal panel arranged together with a polarizing beam splitter in order to direct the modulated light beam through the projection lens. However, the arrangement of the liquid crystal panel and the polarizing beam splitter results in a displayed image, which may appear fuzzy and lacking in contrast.

Thus, there is a need for an image projection device, which can be produced at a small size and still maintain a high quality image projection.

### SUMMARY OF THE INVENTION

It is an object of the present invention to provide one or more illumination systems, which can be used in order to produce an image projection device, which may have a small size and still provide a high quality image.

According to a first aspect of the invention, there is provided an illumination system comprising:
at least three diode and/or laser light sources including a red, a green and a blue light source,
at least three polarizing light converting elements corresponding to each colour of light sources,
at least three liquid crystal panels corresponding to each colour of light sources, and
at least one prism arrangement,
wherein red light is directed through a first polarizing light element and a first liquid crystal panel into a first side of the prism arrangement, green light is directed through a second polarizing light element and a second liquid crystal panel into a second side of the prism arrangement, and blue light is directed through a third polarizing light element and a third liquid crystal panel into a third side of the prism arrangement, and
wherein the prism arrangement is adapted to reflect or emit the polarized light received at the first, second and third prism sides in a single direction throughout a fourth side being an exit plane of the prism.

According to a preferred embodiment of the first aspect of the invention, the illumination system further comprises a projection lens with the prism arrangement being adapted to reflect or emit the polarized light received at the first, second and third prism sides in a single direction throughout the fourth side of the prism and through the projection lens. Here, it is preferred that the optical distance from each of the liquid crystal panels to the projection lens is substantially equal.

For the first aspect of the invention it is preferred that the prism arrangement comprises a dichroic prism or a cross dichroic prism.

Preferably, the liquid crystal panel is arranged parallel to the first prism side, the second liquid crystal panel is arranged parallel to the second prism side, and the third liquid crystal panel is arranged parallel to the third prism side.

For the first aspect of the invention it is also preferred that the first polarizing light element is arranged parallel to the first liquid crystal panel, the second polarizing light element is arranged parallel to the second liquid crystal panel, and the third polarizing light element is arranged parallel to third liquid crystal panel.

It is further preferred that the light sources are arranged so that the resulting light is directed substantially perpendicular to the corresponding polarizing light element.

Several solutions for the light sources may be used according to the first aspect of the present invention. Here, one or more or each light source may be a single light emitting diode or an array of light emitting diodes, with each array holding a plurality of light emitting diodes of similar colour. It is also within an embodiment of the first aspect of the invention that one or more or each light source comprises a laser or a laser diode. The first aspect of the invention also covers an embodiment wherein one or more of the light sources comprise a combination of a light emitting diode or an array of light emitting diodes and a laser diode or laser.

It is also within an embodiment of the first aspect of the invention that the illumination system further comprises circuitry for controlling each liquid crystal panel as a function of an image or video input signal, whereby the polarized light received at the first, second and third prism sides represents three colour modulated versions of the same image, said three image versions being modulated by polarized red, green and blue light, respectively. Here, the first, second and third liquid crystal panels may be arranged or aligned relatively to each other so that the light reflected by the prism throughout the exit plane of the prism represents a colour image being a combination of the received three colour modulated image versions.

It is also preferred that the illumination system of the first aspect of the invention further comprises power supply circuitry for supplying power to each light source. Here, the power supply circuitry may be adapted for an individual control or adjustment of the power delivered to the light sources.

According to a second aspect of the present invention there is provided a light source module comprising:
at least a first diode or laser light source providing light in the visible range,
at least a second light source comprising an UV (ultra-violet) or a low wavelength blue diode or laser light source, and
a beam splitter or reflection system,
wherein the beam splitter or reflection system is arranged to emit light received from the first light source and light received from the second light source. It is preferred that the first light source providing visible light comprises a single colour diode or laser light source. Here, the colour provided by the single colour diode or laser light source may be selected from the group consisting of: red, green, blue and white colours.

It is within a preferred embodiment of the second aspect of the invention that the light source providing visible light is a blue diode light source providing blue diode light.

For the embodiments of the present invention having a module or system with a low wavelength blue light source such as a low wavelength blue diode or laser light source, it is meant that when a module or system has another light source providing blue light, then the wavelength of the low wavelength blue light source is lower than the wavelength of the other blue light source. As an example, the low wavelength blue light source may have a wavelength in the range of 410-455 nm while the other blue light source may have a wavelength above 460 nm such as about 468 nm. If the module or system having a low wavelength blue light source does not have another light source providing blue light, then it is preferred that the low wavelength blue light source has a wavelength in the range of 410-455 nm.

Also for the second aspect of the invention several solutions for the light sources may be used. Here, one or more light sources may be a single light emitting diode or an array of light emitting diodes, with each array holding a plurality of light emitting diodes of similar colour. It is also within an embodiment of the second aspect of the invention that one or more light sources comprise a laser or a laser diode. The second aspect of the invention also covers an embodiment wherein one or more of the light sources comprise a combination of a light emitting diode or an array of light emitting diodes and a laser diode or laser.

According to an embodiment of the second aspect of the invention the beam splitter or reflection system is arranged to emit light received from the first light source and light received from the second light source in a direction throughout a single exit plane of the beam splitter or reflection system.

It is also within an embodiment of the second aspect of the invention that the light from the first and second light sources received by the beam splitter or reflection system is emitted from the beam splitter or reflection system in a single direction or along a single optical axis.

The second aspect of the invention also covers an embodiment, wherein the light source module further comprises a polarizing light element, and wherein the light from the first and second light sources emitted by the beam splitter or reflection system is directed through said polarizing light element.

The second aspect of the invention also covers an embodiment, wherein the light source module further comprises a liquid crystal panel, and wherein the light from the first and second light sources being emitted by the beam splitter or reflection system is directed through said liquid crystal panel.

The second aspect of the invention also covers an embodiment, wherein the light source module further comprises a polarizing light element and a liquid crystal panel, wherein the light from the first and second light sources being emitted by the beam splitter or reflection system is directed through the polarizing light element and the liquid crystal panel.

It is within an embodiment of the second aspect of the invention that the polarizing light element and/or the liquid crystal panel are/is arranged parallel to the exit plane of the beam splitter or reflection system.

It is also within an embodiment of the second aspect of the invention that the light source module further comprises a projection lens or lens system, and wherein the light being directed through the liquid crystal panel is further directed through the projection lens or lens system.

It is also within an embodiment of the second aspect of the invention that the light source module further comprises power supply circuitry for supplying power to each light source. Here, the power supply circuitry may be adapted for an individual control or adjustment of the power delivered to the diode light sources.

According to a third aspect of the invention there is provided an illumination system comprising:
a plurality of diode and/or laser light modules, and
a prism arrangement surrounded by the plurality of light modules and arranged so as to emit a combination of lights received from the plurality of light modules, wherein at least one of said plurality of light modules is a UV (ultra-violet) or low wavelength blue light module comprising a first light source having a UV or low wavelength blue diode or laser light source. Here, the UV or low wavelength blue light module may further comprise a second visible diode or laser light source, and a beam splitter or a reflection system, wherein the beam splitter or reflection system is arranged to emit light received from the first and second light sources. It is preferred that the beam splitter or reflection system is arranged to emit light received from the first and second light sources in a direction throughout a single exit plane of the beam splitter or reflection system. The second visible light source may be a blue diode or laser light source or a green diode light source, but in a preferred embodiment the second light source is a blue diode light source.

It is within an embodiment of the third aspect of the invention that the prism arrangement comprises a cubical prism. It is also within an embodiment of the third aspect of the invention that the prism arrangement comprises a dichroic prism or a cross dichroic prism.

It is within a preferred embodiment of the third aspect of the invention that the prism has a first side, a second side, a third side and a fourth side, and that the plurality of light modules comprises three modules with a first module emitting light into the first side of the prism, a second module emitting light into the second side of the prism, and a third module emitting light into the third side of the prism. Here, it is preferred that the prism arrangement is adapted to emit the combination of lights received at the first, second and third prism sides in a single direction throughout the fourth side of the prism.

According to an embodiment of the third aspect of the invention the plurality of light modules may further comprise a red light module with a red diode and/or laser light source and a green light module with a green diode light source. Here, the first light module may be the red light module, the second light module may be the green light module and the third light module may be the UV or low wavelength blue light module.

The third aspect of the invention also covers an embodiment, wherein each light module comprises a corresponding polarizing light element. Here, it is preferred that for each light module the emitted light is directed through the corresponding polarizing light element and into the prism arrangement.

It is also within an embodiment of the third aspect of the invention that each light module comprises a corresponding liquid crystal panel. Here, it is preferred that for each light module the emitted light is directed through the corresponding polarizing light element and the corresponding liquid crystal panel and into the prism arrangement. It is also within an embodiment of the third aspect of the invention that each polarizing light element and/or each liquid crystal plane are/is arranged parallel to a corresponding side of the prism arrangement.

The third aspect of the invention also covers embodiments wherein the light modules do not comprise a corresponding liquid crystal panel. But here, a liquid crystal panel or element may be arranged on a light outgoing side of the prism arrangement.

The third aspect of the invention also covers embodiments, wherein the illumination system further comprises a Digital Light Processing unit, which Digital Light Processing Unit may be arranged on a light outgoing side of the prism arrangement. In one embodiment, wherein the Digital Light Processing unit may be a 3-chip Digital Light Processing unit, an optical lens and a second prism may further be arranged on the light outgoing side of the prism arrangement so that the outgoing light from the prism arrangement is directed through the optical lens and reflected by the second prism as light input to the Digital Light Processing unit. The illumination system may further comprise a projections lens or outgoing lens system, and the second prism and the Digital Light Processing unit may be arranged so and so that light output from the Digital Light Processing unit is transmitted through the second prism and directed through the projection lens or outgoing lens system. In an alternative embodiment, wherein the Digital Light Processing unit may be a 1-chip Digital Light Processing unit, a condensing lens, a colour filter and a shaping lens may further be arranged on the light outgoing side of the prism arrangement so that the outgoing light from the prism arrangement is directed through the condensing lens, the colour filter and the shaping filter on to the surface of the Digital Light Processing unit. Also for this alternative embodiment, the illumination system may further comprise a projection lens or outgoing lens system, and the light output from the Digital Light Processing unit may be directed through the projection lens or outgoing lens system.

It is within an embodiment of the third aspect of the invention that the illumination system further comprises a projection lens or lens system, and wherein the light being emitted from the prism arrangement is further directed through said projection lens or lens system. Here, it is preferred that when the illumination system comprises several liquid crystal panels, then the optical distance from each of the liquid crystal panels to the projection lens is substantially equal.

According to an embodiment of the third aspect of the invention, the UV or low wavelength blue light source may comprise a UV light emitting diode.

Also for the third aspect of the invention several solutions for light sources of the light modules may be used. Here, one or more light sources of the light modules may be a single light emitting diode or an array of light emitting diodes, with each array holding a plurality of light emitting diodes of similar colour. It is also within an embodiment of the third aspect of the invention that one or more light sources of the light modules comprise a laser or a laser diode. The third aspect of the invention also covers an embodiment wherein one or more of the light sources of the light modules comprise a combination of a light emitting diode or an array of light emitting diodes and a laser diode or laser. Thus, one or more of the light source modules may comprise an array of light emitting diodes, with each array holding a plurality of light emitting diodes of similar colour. It is also within an embodiment of the third aspect of the invention that part of or each of the light source modules comprises a laser or a laser diode.

For embodiments of the third aspect of the invention wherein each diode light module comprises a corresponding polarizing light element and a corresponding liquid crystal panel, it is preferred that the illumination system further comprises circuitry for controlling each liquid crystal panel as a function of an image or video input signal, whereby the polarized light received by the prism arrangement represents three colour modulated versions of the same image. Here, the illumination system may have a first, second and third liquid crystal panel, which are arranged or aligned relatively to each other so that the light emitted by the prism arrangement represents a colour image being a combination of the received three colour modulated image versions.

It is also within an embodiment of the third aspect of the invention that the illumination system further comprises power supply circuitry for supplying power to each light modules, said power supply circuitry being adapted for an individual control or adjustment of the power delivered to the light modules.

According to a fourth aspect of the invention there is provided a projection illumination system comprising:
a plurality of projection modules, each said projecting module comprising one or more diode and/or laser light sources and one or more light modulating units and a projection lens or lens assembly, each said light modulating unit comprising a liquid crystal panel or a Digital Light Processing unit,
wherein, for each projection module, the light sources, the light modulating unit(s) and the projection lens are arranged for projecting modulated light through the projection lens, and
wherein the projection lenses are arranged for projecting the modulated light on a single projection screen.

For illumination systems according to the fourth aspect of the invention wherein one or more light modulating units comprise a liquid crystal panel, it is preferred that each of the projecting modules further comprises at least one polarizing light element.

It is within an embodiment of the fourth aspect of the invention that for each liquid crystal panel, there is one or more corresponding polarizing light elements, said polarizing light element(s) being arranged in the optical path(s) between the liquid crystal panel and the light source(s) having light modulated by said liquid crystal panel.

The fourth aspect of the invention also covers an embodiment, wherein the light sources include one or more UV (ultra-violet) or low wavelength blue light sources.

For the system of the fourth aspect of the invention it is preferred that the system comprises at least two projection modules, such as two or three projection modules.

According to an embodiment of the fourth aspect of the invention, then at least one of the projection modules may further comprise a prism arrangement arranged for having three different light sources emitting light into three corresponding sides of the prism, said prism arrangement being adapted to emit the combination of lights received at said three prism sides in a single direction throughout at fourth side of the prism and through the projection lens of the projection module.

The fourth aspect of the invention also covers embodiments, wherein at least one of the projection modules having a prism arrangement is a DLP projection module with a light modulating unit having a Digital Light Processing unit. The Digital Light Processing Unit may be arranged on a light outgoing side of the prism arrangement. In one embodiment, wherein the Digital Light Processing unit may be a 3-chip Digital Light Processing unit, an optical lens and a second prism may further be arranged on the light outgoing side of the prism arrangement so that the outgoing light from the prism arrangement is directed through the optical lens and reflected by the second prism as light input to the Digital Light Processing unit. The second prism and the Digital Light Processing unit may be arranged so that light output from the Digital Light Processing unit is transmitted through the second prism and directed through the projection lens. In an alternative embodiment, wherein the Digital Light Processing unit may be a 1-chip Digital Light Processing unit, a condensing lens, a colour filter and a shaping lens may further be arranged on the light outgoing side of the prism arrangement so that the outgoing light from the prism arrangement is directed through the condensing lens, the colour filter and the shaping filter on to the surface of the Digital Light Processing unit, and the light output from the Digital Light Processing unit may be directed through the projection lens.

It is also within an embodiment of the fourth aspect of the invention that for a projection module having the prism arrangement, a liquid crystal panel may be arranged in the optical path between the fourth side of the prism and the projection lens. Here, a polarizing light element may be arranged in the optical path between the fourth side of the prism and the liquid crystal panel. Alternatively, then for each of the three light sources a polarizing light element may be arranged in the optical path between the light source and the corresponding side of the prism.

It is within an embodiment of the fourth aspect of the invention that the prism arrangement comprises a cubical prism. It is also within an embodiment of the fourth aspect of the invention that the prism arrangement comprises a dichroic prism or a cross dichroic prism.

According to an embodiment of the system of the fourth aspect of the invention, wherein a projection module has the prism arrangement, then for each of the three light sources a polarizing light element may be arranged in the optical path between the light source and the corresponding side of the prism, and a liquid crystal panel may be arranged in the optical path between the polarizing light element and the corresponding side of the prism. Here, it is preferred that for a projection module having the prism arrangement arranged for having three different light sources emitting light into three corresponding sides of the prism through the three liquid crystal panels, the optical distance from each of the liquid crystal panels to the projection lens is substantially equal.

According to an embodiment of the system of the fourth aspect of the invention, wherein a projection module has the prism arrangement, the three different light sources may include a red, a green and a blue light source.

The system of the fourth aspect of the invention also covers an embodiment, wherein a projection module has the prism arrangement, and wherein one of the three different light sources includes a UV (ultra violet) or low wavelength blue light source. Here, one of the three different light sources may be a combined light source having both a first UV or low wavelength blue light source and a second light source for providing light in the visible range.

It is within one or more embodiments of the system of the fourth aspect of the invention that at least one of the projection modules comprises a combined light source having both a first UV or low wavelength blue light source and a second light source for providing light in the visible range. It is preferred that for the combined light source, the visible light source is a blue or green light source.

For a system according to an embodiment of the fourth aspect of the invention having a projection module comprising the combined diode light source, then the combined light source may comprise a beam splitter or reflection system, said beam splitter or reflection system being adapted for emitting light received from the first and second light sources along a single optical direction thereby providing the light output of the combined light source. Here, for a projection module having a combined light source, a polarizing light element may be arranged in the optical path between the beam splitter or the reflection system and the projection lens, and a liquid crystal panel may be arranged in the optical path between the polarizing light element and the projection lens.

According to one or more embodiments of the fourth aspect of the invention, then at least one of the projection modules may comprise a single colour diode light source for providing light in the visible range. Here, the visible diode light source may be a blue or green diode light source. For a projection module having a single colour diode light source, then a polarizing light element may be arranged in the optical path between the diode light source and the projection lens, and a liquid crystal panel may be arranged in the optical path between the polarizing light element and the projection lens.

Also for the fourth aspect of the invention several solutions for light sources of the projection modules may be used. Here, one or more light sources of a projection module may be a single light emitting diode or an array of light emitting diodes, with each array holding a plurality of light emitting diodes of similar colour. It is also within an embodiment of the fourth aspect of the invention that one or more light sources of a projection module comprise a laser or a laser diode. The fourth aspect of the invention also covers an embodiment wherein one or more of the light sources of a module comprise a combination of a light emitting diode or an array of light emitting diodes and a laser diode or laser. It is within an embodiment of the fourth aspect of the invention that the light sources include a red, a green and a blue light source. It is also within an embodiment of the fourth aspect of the invention that the light sources include two blue and/or two green light sources. Here, it is preferred that the light sources include at least two blue light sources which may be diode light sources.

For a system according to an embodiment of the fourth aspect of the invention having a projection module comprising a UV light source, then it is preferred that the UV light source is a UV light emitting diode.

It is within an embodiment of the system of the fourth aspect of the invention, that the optical distance from the liquid crystal panel(s) of a projection module to the corresponding projection lens is substantially equal for all projection modules.

In order to optical align the projection modules of a system of the fourth aspect of the invention, then it is preferred that that for at least one of the projection modules, the position of the projection lens can be adjusted in relation to the position of the liquid crystal panel(s). According to an embodiment of the fourth aspect of the invention then the system may comprise three projection modules arranged in a row, and wherein for at least the two outermost arranged projection modules, the position of the projection lens can be adjusted in relation to the position of the liquid crystal panel(s).

It is also within an embodiment of the system of the fourth aspect of the invention that the position of at least one of the projection modules can be adjusted in relation to the remaining projection modules.

Also for the systems of the fourth aspect of the invention it is preferred that the illumination system further comprises circuitry for controlling each liquid crystal panel as a function of an image or video input signal, whereby the light or polarized light received by the projection lenses represents colour modulated versions of the same image.

It is also within an embodiment of the fourth aspect of the invention that the illumination system further comprises power supply circuitry for supplying power to each diode light source. Here, the power supply circuitry may be adapted for an individual control or adjustment of the power delivered to the diode light source.

The invention will be further described in the following with the aid of the accompanying drawing.

### BRIEF DESCRIPTION OF THE DRAWINGS

FIGS. 1a and 1b are plan views schematically showing illumination systems according to a first and a second embodiment of the first aspect of the present invention,

FIG. 2 is a schematic diagram of the illumination system of FIG. 1 further including circuitry for controlling modulation of liquid crystal panels and circuitry for supplying power to diode light sources according to an embodiment of the present invention,

FIG. 3 is a schematic diagram showing the layout of a light emitting diode array according to an embodiment of the present invention,

FIG. 4 is a schematic diagram illustrating the arrangement of a projection lens according to an embodiment of the first aspect of the present invention,

FIG. 5 is a schematic diagram illustrating the power supply circuitry used for supplying power to the diode light sources according to an embodiment of the present invention,

FIG. 6a is a plan vies schematically showing a UV light source module according to an embodiment of the second aspect of the invention,

FIG. 6b is a plan view schematically showing an illumination system according to a first embodiment of the third aspect of the invention,

FIG. 6c is a plan view schematically showing an illumination system according to a second embodiment of the third aspect of the invention,

FIG. 6d is a plan view schematically showing an illumination system according to a third embodiment of the third aspect of the invention,

FIG. 6e is a plan view schematically showing an illumination system according to a fourth embodiment of the third aspect of the invention,

FIG. 6f is a plan view schematically showing an illumination system according to a fifth embodiment of the third aspect of the invention,

FIG. 7 is a plan view schematically showing an illumination system according to a sixth embodiment of the third aspect of the invention,

FIG. 8a is a plan view schematically showing a projection illumination system according to a first embodiment of the fourth aspect of the invention,

FIG. 8b is a plan view schematically showing a projection illumination system according to a second embodiment of the fourth aspect of the invention,

FIG. 9a is a plan view schematically showing a projection illumination system according to a third embodiment of the fourth aspect of the invention,

FIG. 9b is a plan view schematically showing a projection illumination system according to a fourth embodiment of the fourth aspect of the invention,

FIG. 10 is a plan view schematically showing a projection illumination system according to a fifth embodiment of the fourth aspect of the invention,

FIG. 11 is a plan view schematically showing a projection illumination system according to a sixth embodiment of the fourth aspect of the invention,

FIG. 12 is a plan view schematically showing a projection illumination system according to a seventh embodiment of the fourth aspect of the invention,

FIG. 13 is a plan view schematically showing a projection illumination system according to an eight embodiment of the fourth aspect of the invention,

FIG. 14 is a plan view schematically showing a projection illumination system according to a ninth embodiment of the fourth aspect of the invention,

FIG. 15 is a plan view schematically illustrating optical alignment of a projection illumination system according to the first embodiment of the fourth aspect of the invention,

FIG. 16 is a front view schematically illustrating a first embodiment of movement directions of projection lenses used for the optical alignment of the projection illumination system shown in FIG. 15, and

FIG. 17 is a front view schematically illustrating a second embodiment of movement-directions of projection lenses used for the optical alignment of the projection illumination system shown in FIG. 15.

### DETAILED DESCRIPTION OF THE INVENTION

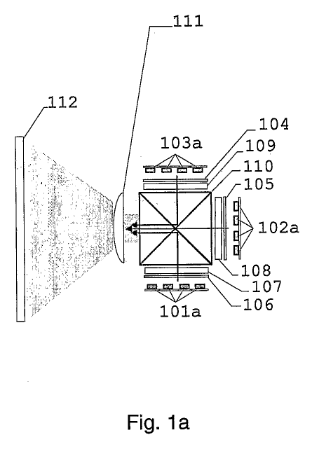

A first embodiment of an illumination system according to the first aspect present invention using diode light sources is illustrated in FIG. 1a. Here, three light emitting diode (LED) arrays 101a-103a are arranged as diode light sources, where the first array 101a has diodes giving the colour red, the second array 102a has diodes giving the colour green, and the third array 103a has diodes giving the colour blue. In front of each LED array 101a-103a is arranged a polarizing filter 104-106, with each polarizing filter being arranged in front of or attached to a liquid circuit display (LCD) 107-109. The three LCD's, 107-109, are arranged on three sides of a cross dichroic prism 110, with a projection lens 111 being arranged in front of a fourth side of the prism 110. The prism 110 combines the three colour images modulated by the three LCD's 107-109, to form a colour image being projected by the lens 111. In FIG. 1a is also shown a projection screen 112 on which the image is being projected.

A second embodiment of an illumination system according to the first aspect of the present invention using light sources is illustrated in FIG. 1b. The system of FIG. 1b is similar to the system of illustrated in FIG. 1a with the exception that the in FIG. 1b the light sources are single light emitting diodes, single lasers or laser diodes, 101b-103b. The remaining components of the system of FIG. 1b are similar to the components of FIG. 1a and therefore the same numerals are used for these components in FIG. 1a and FIG. 1b.

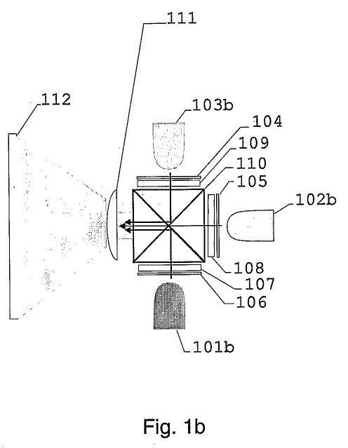

FIG. 2 includes the illumination system of FIG. 1b, but further includes circuitry 210 for controlling image modulation of the LCD's 107-109 and circuitry 211 for supplying power to the diode light sources 101b-103b.

### Light Emitting Diodes

Example using Light Emitting Diode Arrays

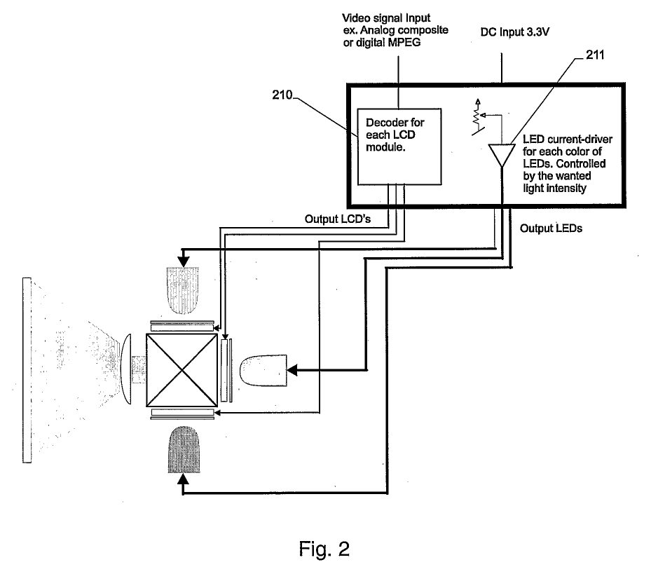

In FIG. 3 is shown the layout of a light emitting diode array 301, which may be used in the embodiment illustrated in FIG. 1a. The diode array 301 contains 9 LED's 302 and 9 resistors 303. Three diode arrays 301 are used for the system of FIG. 1a, a red colour array 101a, a green colour array 102a, and a blue colour array 103a.

According to an embodiment of the invention, the following LED units have been used for the arrays:

Array 101a: Ultrahelle tiefrote SMD-LED 0603, 45 mcd, 120°,
Array 102a: Ultrahelle grúne SMD-LED 0603, 65 mcd, 120°,
Array 103a: Ultrahelle blau SMD-LED 0603, 60 mcd, 120°,

Here, SMD-LED 0603 is the LED product number, xx mcd (millicandel) is the brightness/amount of light generated by the LED, and 120° is the angle in which the light from the LED is distributed.

For an embodiment of the invention, the current through the LED's may be non adjustable, and for these LED arrays the following resistors may be used:

Array 101a: , ¼ Watt, 76.50 Ohm
Array 102a: 0805, ⅛ Watt, 107 Ohm
Array 103a: 0805, ¼ Watt, 107 Ohm

### Example Using Single LED Diodes

A number of single LED diodes may be used instead of LED arrays. This is illustrated in the embodiment of FIG. 1b. Here, one red LED unit, one green LED unit, and one blue LED unit are used. According to an embodiment of the invention, the following single diode LED units have been used:

Diode 101b: Luxeon® Star/O red, 1 Watt, 810.000 mcd, 10°
Diode 102b: Luxeon® Star/O green, 1 Watt, 600.000 mcd, 10°
Diode 103b: Luxeon® Star/O blue, 1 Watt, 200.000 mcd, 10°

Here, xx mcd is the amount of light generated by the LED, and 10° is the angle in which the light from the LED is distributed.

### Laser Light Sources

The present invention also covers embodiments wherein part of or all of the light sources are laser light sources. Laser light sources may be used to obtain a higher light output power when compared to the light output delivered by light emitting diodes.

A laser is a device that controls the way that energized atoms release photons. “Laser” is an acronym for light amplification by stimulated emission of radiation, which describes very succinctly how a laser works.

In the following are some typical lasers and their emission wavelengths:

| Laser Type | Wavelength (nm) |
|---|---|
| Argon fluoride (UV) | 193 |
| Krypton fluoride (UV) | 248 |
| Xenon chloride (UV) | 308 |
| Nitrogen (UV) | 337 |
| Argon (blue) | 488 |
| Argon (green) | 514 |
| Helium neon (green) | 543 |
| Helium neon (red) | 633 |
| Rhodamine 6G dye (tunable) | 570-650 |
| Ruby (CrAlO3) (red) | 694 |
| Nd: Yag (NIR) | 1064 |
| Carbon dioxide (FIR) | 10600 |

Laser medium can be a solid, gas, liquid or semiconductor. Lasers are commonly designated by the type of lasing material employed:
Solid-state lasers have lasing material distributed in a solid matrix (such as the ruby or neodymium:yttrium-aluminum garnet “Yag” lasers). The neodymium-Yag laser emits infrared light at 1,064 nanometers (nm). A nanometer is 1×10-9 meters.
Gas lasers (helium and helium-neon, HeNe, are the most common gas lasers) have a primary output of visible red light. CO2 lasers emit energy in the farinfrared, and are used for cutting hard materials.
Excimer lasers (the name is derived from the terms excited and dimers) use reactive gases, such as chlorine and fluorine, mixed with inert gases such as argon, krypton or xenon. When electrically stimulated, a pseudo molecule (dimer) is produced. When lased, the dimer produces light in the ultraviolet range.
Dye lasers use complex organic dyes, such as rhodamine 6G, in liquid solution or suspension as lasing media. They are tunable over a broad range of wavelengths.
Semiconductor lasers, also referred to as laser diodes. These electronic devices are generally very small and use low power. They may be built into larger arrays, such as the writing source in some laser printers or CD players.

For the systems of the present invention, then when the total size of the illumination systems or light modules has to be taken into account, then laser diodes are preferred as light source when compared to other laser types. Semiconductor laser diodes covering wavelengths within the visible range are commercially available and supplied by a great number of manufactures.

### Polarizing Filters

The purpose of polarizing filters 104-106 is to control light from the LED arrays 101a-103a into the LCD's 107-109. If an electrical charge is applied to an LCD, the LCD untwist, thereby changing the angel of light passing through. However, this change is not visible by the human eye unless a polarizing filter is applied in front of the LCD. This means that the polarizing filters 104-106 are necessary for making the light changes within the LCD's 107-109 visible for the human eyes.

The wavelength λ of the blue SMD-LED 0603 is 468 nm. Consequently, the following polarizing filter from CVI Laser Optics can be applied: TFP-527-PW-1025-UV. The polarizing filter “TFP-527-PW-1025-UV” has a transmission efficiency of 95% for λ>=527 nm. However, due to the dimensions of this particular filter type, it may be necessary to resize the polarizing filter glass into the size needed in the apparatus.

The wavelength λ of the green SMD-LED 0603 is 520 nm. Consequently, the following polarizing filter can be applied: ColorPol® VIS500BC3. The ColorPol® VIS500BC3 polarizer has a Transmission Efficiency of 72% for A=520 nm with contrast >1000:1

The wavelength λ of the red SMD-LED 0603 is 660 nm. Consequently, the same polarizing filter can be used as for the green LED array. For the red LED array the ColorPol® VIS500BC3 polarizer has a Transmission Efficiency of 83% for λ=660 nm with contrast >1000:1

### Liquid Crystal Displays

The three LCD's 107-109 in FIGS. 1a and 1b are each being controlled by a corresponding video or image to LCD decoder or converters being part of the circuitry 210 in FIG. 2. There is one decoder or converter for each of the colours red, green and blue. The video or image to LCD decoders are standard decoders or converters for converting for example video, mpg, RGB of DVI input signals.

### LCD Positioning

For the illumination system of FIGS. 1a or 1b to achieve an ultimate high quality displayed picture/image with high sharpness and contrast, then the three LCD's 107-109, which preferably are attached to the prism 110, should be fine tuned in position, so that all three colours of light entering the LCD's and exiting the projection lens 112 come together substantially exactly on top of each other on, for example, a white wall or canvas. All parts of the system of FIGS. 1a or 1b should preferably be assembled and fine tuned in position when leaving the production assembling line. However, fine tuning of the system can all so be achieved manually.

The LCD's 107-109 can be attached to the prism 110 by means of a material such as miniature screws or glue.

### Prism

The prism 110 of FIGS. 1a and 1b may be a dichroic prism designed to fit to the LDC's used for the illumination system. In FIG. 1a the diode arrays 101a and 103a are arranged parallel and opposite to each other with the diode light of these arrays entering the prism 110 at a direction being substantially perpendicular to the exit plane of the prism, while the diode array 102a is arranged opposite to the exit plane of the prism, whereby the diode light of the array 102a is entering the prism at a direction being substantially equal to the light output direction.

The dichroics prism 110 may be customised to fit the size of various illumination systems. The dichroic prism can be formed by combining four triangular poles also named “right angle prisms” to create one rectangular solid prism. High precision is required in the processing and adhesion of poles to avoid dark lines and double images caused by misaligned discrete dichroic surfaces. In addition, the dichroic prism 110 may be coated according to the wavelengths of the diode light sources 101-103, to thereby act as a beam-splitter. When using 0.1 inch LCD's the side lengths of the prism 110 should be at least 0.1 inch each.

### Example

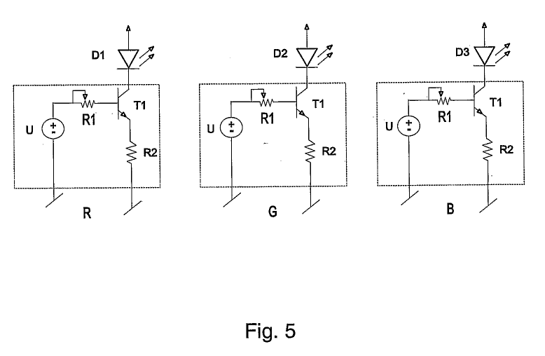

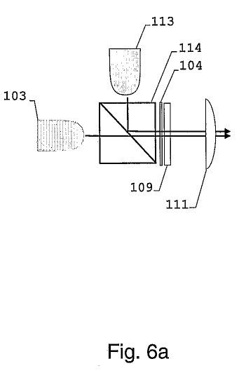

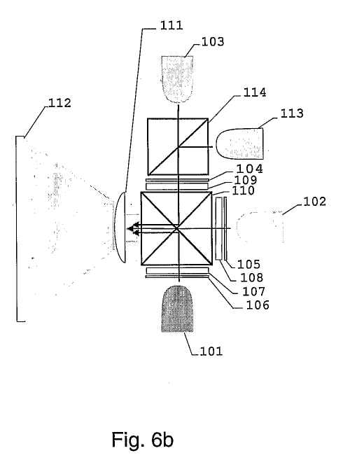

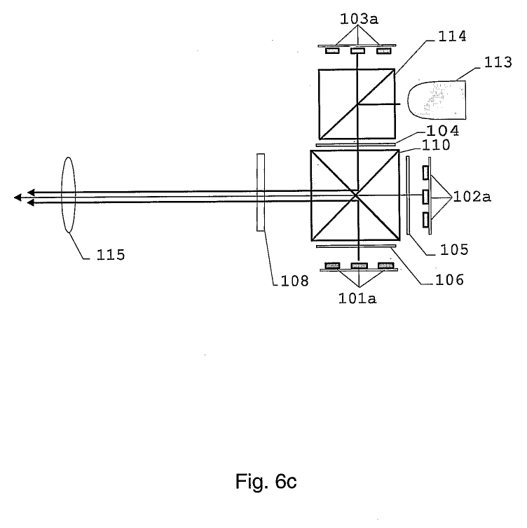

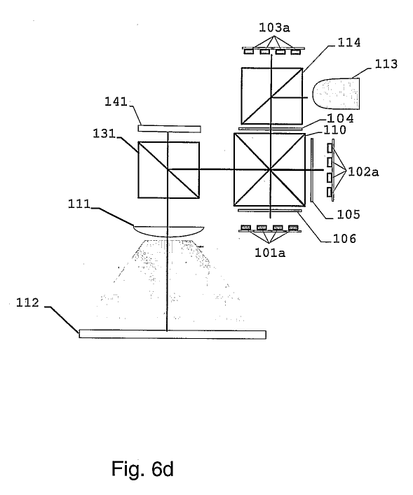

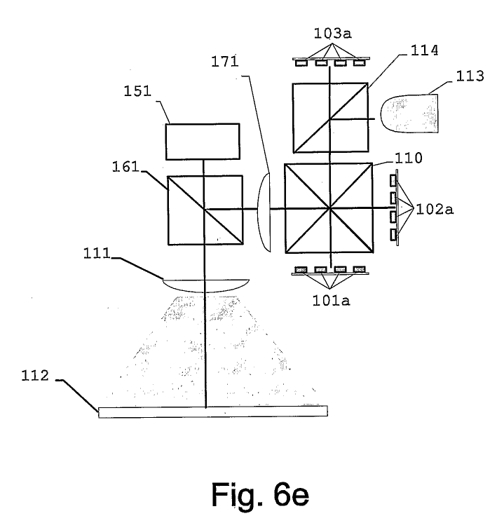

The blue LED array 103a in the above described diode array example has a wavelength of 468 nm. Thus, the dichroic prism 110 may be coated to reflect substantially all the blue diode light (coming from the blue entry side of the prism 110) on to the optical axis within a wavelength range of 390-494 nm. However. if ultra violet, UV, light is applied to the system in combination with the blue diode light, as discussed in accordance with the system illustrated in FIG. 6b, then the diachronic prism 110 may be coated to reflect light of wavelengths in the range of 240-494 nm.

The red LED array 101a has a wavelength of 660 nm. Thus, the dichroic prism 110 may be coated to reflect substantially all red diode light (coming from the red entry side of the prism 110) on to the optical axis within a wavelength range of 591-685 nm.

The green LED 102a array has a wavelength of 520 nm. Here, it is important that the red and blue diode light is not interfering with the green diode light, and the prism 110 should be coated to transmit substantially all the green diode light within a wavelength range of 495-590 nm.

### Projection Lens

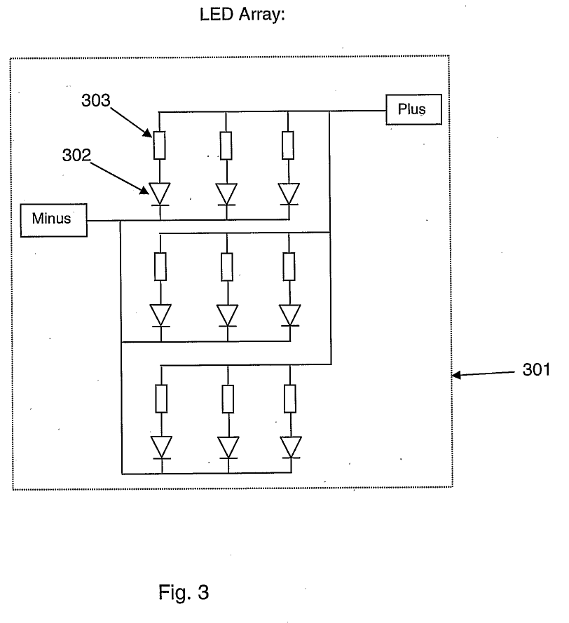

FIG. 4 is a schematic diagram illustrating the arrangement of a projection lens 111 according to an example of the present invention. It should be noted that according to an embodiment of the illumination system of the present invention, it is preferred to use an achromatic lens for the projection lens 111.

### Achromatic Lenses:

Achromatic lenses are superior to singlets lenses for infinite conjugate distances and large apertures. Consequently, it may be an obvious choice for improving the apparatus to use an achromatic lens.

An achromatic lens consists of two optical components cemented together, usually a positive low-index (crown) element and a negative high-index (flint) element. The additional design freedom provided by using doublets lenses allows for further optimization of performance not possible with singlets lenses. Therefore, achromatic lenses may have noticeable advantages over simple lenses. Achromatic lenses may be far superior to simple lenses for multi-colour (“white light”) imaging. The two elements composing an achromatic lens (literally, “a lens with no colour”) are paired together for their ability to correct the colour separation inherent in glass. Having eliminated the problematic chromatic aberrations, achromatic lenses may become the most cost-efficient means for good polychromatic illumination and imaging.

Freedom from spherical aberration and coma implies better on-axis performance at larger apertures. Unlike simple lenses, achromatic lenses may provide consistently smaller spot sizes and superior images without decreasing the clear aperture. Because on-axis achromatic performance will not deteriorate with larger clear apertures, “closing down” the optical system becomes unnecessary.

The example illustrated in FIG. 4 is based on the following:

To find the right projection lens with the correct specifications, it may necessary to make calculations with regards to the dimensions of the apparatus and the expected screen size. In FIG. 4 is shown the optical axis and the distance S from the LCD 108 at the back of the prism 110 to the projection lens 111 and the distance S′ from the lens 111 to a projection screen/canvas or wall 112.

To calculate the type and size of projection lens for the apparatus the following calculation formulas may be used:

Magnification Equation: M=S′/S or Y=M*X

Thin Lens Equation: 1/S+1/S′=1/f

M=magnification
S′=distance from projection lens to Screen/canvas or white wall
S=distance from the LCD to the Projection lens.
f=focal length
x=Size of LCD
Y=Size of screen

### Calculations:

In this example of the illumination system there is used 0.1″ LCD's. The desired size of the projected picture is around 10″. The distance from the projection lens 111 to a wall or canvas 112 is 100 cm.

Thus the following is given: S=1 cm; S′=100 cm; X=0.1″; Y=10″

M=S′/S=>M=1000 mm/10 mm=>M=100

1/S+1/S′=1/f=>1/10 mm−1/1000 mm=1/f=>f=1/0.1001=>f=9.99=>f>>10 mm

Consequently, the following visible Achromatic Doublets lens available from Thorlabs Inc may be used:

Part nr. AC080-010-A1, focal length (f)=efl:10.00 mm, DIA: 8.0 mm, Material: BAFN10-SFL6

### LED Power Supply

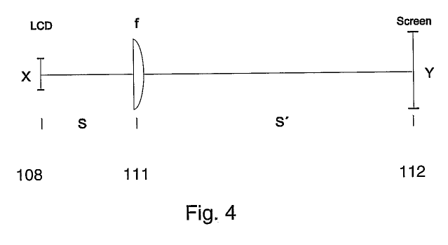

FIG. 5 is a schematic diagram illustrating the power supply circuitry used for supplying power to the diode light sources according to an embodiment of the present invention.

In FIG. 5, each LED or LED array, D1 (red), D2 (green), D3 (blue) is powered by a supply circuit comprising a variable resistor R1, a fixed resistor R2, a transistor T1, and a voltage source U. The power delivered to a diode light source D1, D2, D3 may be manually adjusted bye means of R1. The power to the light sources D1, D2, D3 may also or alternatively be adjusted automatically, which may be achieved bye implementing feedback from a photo-detector.

If a voltage of 3.5 V is needed to drive a diode light source D1, D2, D3 then a supply voltage source U of at least 5 V should be provided. The resistor R1 may be variable in the range of for example 10K Ohm to 35 K Ohm. The value of resistor R2 may be 40 Ohm, while the transistor T1 may have an amplification factor β of about 100. The current of the red diode D1 may be adjusted in the range of 10-30 mA, while the current of green diode D2 and blue diode D3 may be adjusted in the range 10-20 mA. It is preferred that the red diode D1 has a nominal current of 30 mA, while the green diode D2 and the blue diode D3 both have a nominal current of 20 mA.

### Use of Ultra Violet or Low Wavelength Blue Light Source

In order to improve the light output of an illumination system, such as the systems according to the first aspect of the invention, then according to the second, third and fourth aspects of the invention, a UV light source or a low wavelength blue light source may be added. Thus, the UV light or low wavelength blue light may be combined with the visible light colours blue, green, red or white. Using UV light or low wavelength blue as an additional light source may improve the picture quality of the displayed image and also result in a higher light output of the illumination system. Ultra violet light is normally not visible to the human eye. Thus, for the UV light to become visible to the human eye, a light beam projected from an illumination system having a light source combination including a UV light source should be displayed on a special surface such as for example a white canvas coated with a substance such as optical white etc. Standard white Xerox paper can also be used as canvas, for example Xerox paper in the size 3A attached to a wall. However, the selected canvas should preferably have the ability to reflect the UV light. In addition, to enjoy the picture improvements added by the use of UV light, the light level in the physical room and surroundings should be lowered to a minimum. Using standard white Xerox paper as canvas may reflect UV light projected by a projecting illumination system, resulting in a sharper picture and higher brightness. The UV light source in the projecting illumination system may generate a rainbow blue colour, which in combination with a blue colour light source may deliver a higher blue colour level in a projected picture. The colour blue, in general, is the most difficult colour to be transmitted through filters and optics in a projecting illumination system. Therefore, it is important to have as much blue colour as possible. Together with an adjusted level of the colour red and green light source, white light may be achieved and used as means for projecting a picture/image.

### Examples of UV Light Emitting Diodes:

To prevent UV light from damaging the human eye, UV LED's with a long wavelength may be used, for example UV light with a wavelength of 390-400 nm or 400-410 nm. In addition, the longer the UV light wavelength is, the more rainbow blue colour from the UV light is gained. Since a high level of rainbow blue colour from the UV light is desirable, the following UV light wavelengths may be used: 390-400 nm or 400-410 nm. Using a wavelength in the area of 400-410 nm makes it possible to use standard beam splitters made of glass, thus keeping the price of the beam splitter at a low level. Beam splitters with wavelengths in the range of 240-390 nm are much more expensive compared to standard beam splitters made of glass.

According to preferred embodiments of the present invention, the following UV-LED units may be used:

113: Ledtronics part nr. 100CUV395-12D, wavelength 390-400 nm
113: Ledtronics part nr. L200CUV405-12D, wavelength 400-410 nm

### Low Wavelength Blue Light Sources:

For the embodiments of the present invention having a module or system with a low wavelength blue light source such as a low wavelength blue diode or laser light source, it is meant that when a module or system has another light source providing blue light, then the wavelength of the low wavelength blue light source is lower than the wavelength of the other blue light source. As an example, the low wavelength blue light source may have a wavelength in the range of 410-455 nm while the other blue light source may have a wavelength above 460 nm such as about 468 nm. If the module or system having a low wavelength blue light source does not have another light source providing blue light, then it is preferred that the low wavelength blue light source has a wavelength in the range of 410-455 nm. For systems or modules having a low wavelength blue light source together with a light source of a higher wavelength then a beam splitter may be used which reflects light in the range of 410-455 nm, while trans-mitting light of a higher wavelength such as 468 nm.

### Description of Illumination Systems Using UV or Low Wavelength Blue Light Sources

FIG. 6a shows a light source module having a UV or low wavelength blue light source according to an embodiment of the second aspect of the invention. The light source module of FIG. 6a uses two light sources with different wavelengths. However, part of the components used for the module of FIG. 6a may be similar to the components used for the system described in FIGS. 1a and 1b, and therefore the same numerals are used for these components.

The module of FIG. 6a comprises a single colour diode light source 103, a beam splitter 114 coated to reflect UV light or low wavelength blue light, a UV or low wavelength blue light source 113, a polarizing filter 104, a liquid crystal display LCD 109, and a projection lens 111. To add ultra violet or low wavelength blue light to the module, a beam splitter 114 is used. The purpose of the beam splitter 114 is to combine two incident and perpendicular light beams. The beam splitter 114 may be coated to reflect UV light in the wavelength range of 240-410 nm or to reflect low wavelength blue light in the wavelength range of 410-455 nm. UV or low wavelength blue light from the light source 113 is directed into the beam splitter 114, which reflects the UV or low wavelength blue light onto the optical axis of the outgoing light. Light from the other light source 103 is directed through the beam splitter in the direction of the optical axis. The light thus reflected or transmitted into the direction of the optical axis then continues entering the polarizing filter 104 into the LCD 109 and then through the projection lens 111. The colours blue, green, red and white may be selected so that they do not contain the same wavelength as the UV or low wavelength blue light, and it is therefore possible to have a beam splitter allowing light of these colours to pass through the beam splitter. In a preferred embodiment the single colour diode light source 103 is a blue colour diode light source, and it may be an array of light emitting diodes or a single light emitting diode or laser diode.

Several types of beam splitters 114 may be used in a UV or low wavelength blue light source module in order to reflect or transmit UV or low wavelength blue light:
A first type can be a “long wavelength transmitting beam splitter”, transmitting long wavelengths, such as the light from a blue diode light source 103, and reflecting short wavelengths, such as light from a UV or low wavelength blue light source 113. This situation is illustrated in FIG. 6a.
A second type can be a “short wavelength transmitting beam splitter”, transmitting short wavelengths and reflecting longer wavelength. Here, light from the UV or low wavelength blue light source 113 is transmitted through the beam splitter, while light from the blue diode light source 103 is reflected on to the optical axis.

FIG. 6b shows an illumination system according to a first embodiment of the third aspect of the invention. The system of FIG. 6b is a combination of part of the systems according to the first aspect of the invention illustrated in FIG. 1a or FIG. 1b and part of the UV or low wavelength blue light source module illustrated in FIG. 6a. Thus, part of the components used for the system of FIG. 6b may be similar to the components used for the system described in FIGS. 1a or 1b and FIG. 6a, and therefore the same numerals are used for these components.

The system of FIG. 6b corresponds to the systems illustrated in FIG. 1a or FIG. 1b, with the exception that the blue diode light source 103a, 103b has been replaced by a UV or low wavelength blue light source module similar to part of the UV or low wavelength blue light source module of FIG. 6a and comprising a visible blue colour diode light source 103, which may be a single LED or comprise an array of LED's, a UV or a low wavelength blue light emitting diode 113 and a beam splitter 114. Thus, when compared to the system of FIG. 1b, then for the system of FIG. 6b a combination of UV or low wavelength blue diode light and a visible, higher wavelength blue diode light enters prism 110 through the polarizing filter 104 and the corresponding LCD 109.

For the system in FIG. 6b, the beam splitter 114 may be coated to reflect UV light with a wavelength between 240-410 nm or to reflect low wavelength blue light in the wavelength range of 410-455 nm. UV or low wavelength blue light 113 is directed into the beam splitter 114, which reflects the UV or low wavelength blue light on to the optical axis. Higher wavelength blue light from a blue LED array/laser diode 103 is directed through the beam splitter 114. The higher wavelength blue light may have a wavelength about 468 nm, thus allowing the blue light to pass through the beam splitter. The higher wavelength blue light and UV or low wavelength blue light emitted from the beam splitter then continues entering the polarizing filter 104 into the LCD 109 and dichroic prism 110 and exiting through the projection lens 111, with the image being projected on the screen or canvas 112.

For the system of FIG. 6b, the dichroic prism 110 may be coated to reflect the red colour light coming from diode 101 with a wavelength of 591-685 nm. Since UV light has a wavelength of 240-410 nm, the dichroic prism 110 cannot reflect the UV light on to the optical axis if the UV light enters from the red entry side. The prism 110 is further coated so that the green colour light coming for diode 102 with a wavelength of 520 nm is transmitted through the dichroic prism 110. Also here, UV light with a wavelength between 240-410 nm cannot be transmitted through the green light entry side of the prism 110.

FIG. 6c shows an illumination system according to a second embodiment of the third aspect of the invention. The system of FIG. 6c corresponds to the system of FIG. 6b, but in FIG. 6c the LCD's 107, 108 and 109 are omitted. Instead a common LCD 108 is arranged between the prism 110 and the lens system 115. For the system of FIG. 6c, LED arrays are used instead of the single diodes of FIG. 6b, and in FIG. 6c three light emitting diode (LED) arrays 101a-103a are arranged as diode light sources, where the first array 101a has diodes giving the colour red, the second array 102a has diodes giving the colour green, and the third array 103a has diodes giving the colour blue. In addition, a UV or low wavelength blue light source 113 and beam splitter 114 have been added to the blue entry side of the dichroic prism 110. The three polarizing filters 104-106 are arranged on three sides of the cross dichroic prism 110. The prism 110 combines the three colour lights. The Illuminating lights from LED arrays and UV or low wavelength blue light source whose luminance distribution is made uniform are modulated through the LCD 108. The colour lights modulated by the LCD 108 are projected on a screen by a projecting lens optical system 115 so that a projection image whose luminance distribution is satisfactorily made uniform can be obtained.

The dichroic prism 110 of FIG. 6c may be coated to reflect substantially all the blue diode light including UV or low wavelength blue light (coming from the blue entry side of the dichroic prism) on to the optical axis within a wavelength range of 240-494 nm.

FIG. 6d shows an illumination system according to a third embodiment of the third aspect of the invention. The system of FIG. 6d corresponds to the system of FIG. 6c, but in FIG. 6d the common LCD 108 of FIG. 6c has been replaced by a liquid crystal light valve 141 and a polarizing beam splitter 131. In FIG. 6d, the LED array light sources 101a-103a are composed of light emitting diodes corresponding to light sources of red, green, and high wavelength blue, respectively. In addition, a UV or low wavelength blue light source 113 and a beam splitter 114 have been added to the blue entry side of the dichroic prism 110. The three polarizing filters 104-106 are arranged on three sides of a cross dichroic prism 110. The prism 110 combines the UV or low wavelength blue light and three colour lights and lighten up the liquid crystal light valve 141. The polarizing beam splitter 131 functions as a polarizer, which makes uniform the polarized lights incident on the liquid crystal light valve and also functions as an analyser for projection lights. The light modulated by the liquid crystal light valve 141 is projected on screen or canvas 112 by a projection lens 111.

Also here, the dichroic prism 110 may be coated to reflect substantially all the blue diode light including UV or low wavelength blue light (coming from the blue entry side of the dichroic prism) on to the optical axis within a wavelength range of 240-494 nm.

FIG. 6e shows an illumination system according to a fourth embodiment of the third aspect of the invention. The system of FIG. 6e corresponds to the system of FIG. 6d, but in FIG. 6e the crystal light valve 141 and the beam splitter 131 have been replaced by an optical lens 171, a 3-chip Digital Light Processing™ unit 151 and a prism 161.

Also in FIG. 6e, the LED array light sources 101a-103a are composed of light emitting diodes or laser diodes corresponding to light sources of red, green, and high wavelength blue, respectively. In addition, a UV or low wavelength blue light source 113 and a beam splitter 114 have been added to the blue entry side of the dichroic prism 110. The prism 110 combines the UV or low wavelength blue light and three colour lights and lighten up the 3-chip DLP® unit 151. The white light generated by the light sources (red, green, high wavelength blue, UV or low wavelength blue combined) passes through the optical lens 171 and the prism 161, which reflects the light into the 3-chip DLP® unit. The 3-chip DLP® unit contains a colour filtering prism and each DLP® chip comprises a Digital Micromirror Device, DMD. Each DLP® chip is dedicated to one of these three colours; the coloured light, which is reflected by the micromirrors, is then combined and passed through the projection lens 111 to form an image that is projected on screen or canvas 112. The Digital Light Processing™ technology is marketed by Texas Instruments.

Also here, the dichroic prism 110 may be coated to reflect substantially all the blue diode light including -UV or low wavelength blue light (coming from the blue entry side of the dichroic prism) on to the optical axis within a wavelength range of 240-494 nm.

FIG. 6f shows an illumination system according to a fifth embodiment of the third aspect of the invention. The system of FIG. 6f corresponds to the system of FIG. 6e, but in FIG. 6f the 3-chip DLP® 151 of FIG. 6e has been replaced by a 1-chip DLP® 181, while the condensing lens 171 is maintained, and a colour filter (colour wheel) 191 and a shaping lens replaces the prism 161 of FIG. 6e.

Also in FIG. 6f, the LED array light sources 101a-103a are composed of light emitting diodes or laser diodes corresponding to light sources of red, green, and blue, respectively. In addition, a UV or low wavelength blue light source 113 and a beam splitter 114 have been added to the blue entry side of the dichroic prisme 110. The prism 110 combines the UV or low wavelength blue light and three colour lights and lighten up the 1-chip DLP® 181. The white light generated by the light sources (red, green, blue, UV or low wavelength blue combined) passes through a condensing lens 171 and colour wheel filter 191 and shaping lens 172, causing red, green, and blue light to be shone in sequence on the surface of the Digital Micromirror Device, DMD, of the 1-chip DLP®. The switching of the mirrors within the DMD, and the proportion of time the mirrors are “on” or “off” is coordinated according to the colour shining on them. The light, which is reflected by the micromirrors, is then passed through the projection lens 111 to form an image that is projected on screen or canvas 112. The human visual system integrates the sequential colour and sees a full-colour image,

Also here, the dichroic prism 110 may be coated to reflect substantially all the blue diode light including UV or low wavelength blue light (coming from the blue entry side of the dichroic prism) on to the optical axis within a wavelength range of 240-494 nm.

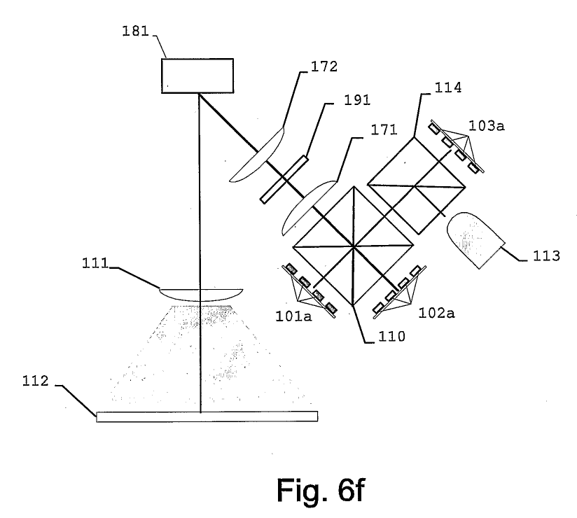

FIG. 7 shows an illumination system according to a sixth embodiment of the third aspect of the invention. The system of FIG. 7 corresponds to the system of FIG. 6b, but in FIG. 7 the beam splitter 114 has been replaced with reflection mirrors 117, 118 and a lens filter lens. The remaining components of the system of FIG. 7 are similar to the components of FIG. 6b and therefore the same numerals are used for these components in FIG. 6b and FIG. 7. In FIG. 7 is shown an alternative way of adding UV or low wavelength blue light to high wavelength blue diode light by use of the lens filter 116 and the reflection mirrors 117, 118 on the blue entry side of prism 110. Light from the high wavelength blue LED or LED array 103 is directed towards the mirror 118, which reflects the light beam on to the lens filter 116. From the lens filter 116 the light beam is emitted into the polarizing filter 104, the LCD 108 and via the prism 110 on to the optical axis. Light from the UV or low wavelength blue light source 113 is directed into the mirror 11, which reflects the light beam on to the lens filter 116. From the lens filter 116 the UV or low wavelength blue light beam is emitted into the polarizing filter 104, the LCD 109 and via the prism 110 on to the optical axis.

The purpose of the lens filter 116 is to filter and redirect the incoming light, reflected by the mirrors 117, 118, on to the optical axis. It is important that the two reflecting mirrors 117, 118 are situated and adjusted in angel (above 45° according to incoming light beam) so that the reflected light beams from the mirrors 117, 118, overlap when projected through the optical axis and on to a canvas 112 or screen. When compared to the system of FIG. 6b, the solution of FIG. 7 is a less effective way to implement UV or low wavelength blue light into the prism 110. The result will be a loss in the amount light emitted from the blue and UV or low wavelength blue light sources 103, 113. Even though this solution is less elegant, the solution can effectively be used when implemented in a system or apparatus with a fixed small picture size (fore example 10″ and with a small distance from the apparatus to the canvas 112, possible less then 1 meter).

It should be understood that for the modules and systems described in connection with FIGS. 6a-6f and FIG. 7, the light emitting diodes, diode arrays or single LED diodes discussed above for use in the systems of FIGS. 1a and 1b may be used. In the same way, the polarizing filters, liquid crystal displays, prism and projection lens discussed above for use in the systems of FIGS. 1a and 1b may be used in the systems of FIGS. 6a-6f and FIG. 7. Also the power supply circuitry an the circuitry for controlling image modulation of the LCD's illustrated and discussed above in connection with FIGS. 2 and 5 for use in the systems of FIG. 1a and 1b may be used in the systems of FIGS. 6a-6f and FIG. 7.

### Description of Projection Illumination Systems Having Several Projection Modules

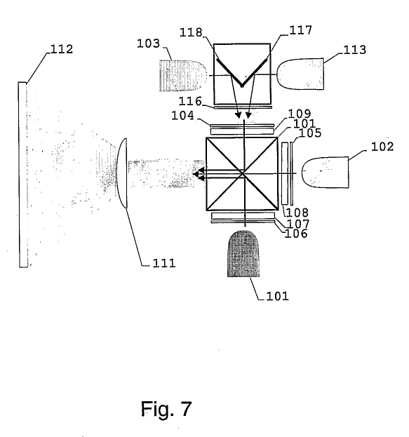

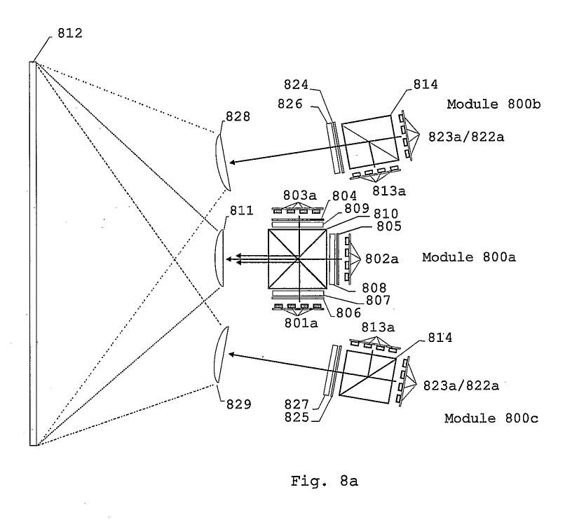

FIG. 8a shows a projection illumination system according to a first embodiment of the fourth aspect of the invention. The system of FIG. 8a comprises three projection modules, 800a, 800b, 800c, where each module has diode light sources and a projection lens, with the projection lenses being arranged or optical aligned in a row so as to project light on the same projection screen 812.

The module 800a corresponds to the system of the first aspect of the invention illustrated in FIG. 1a and the modules 800b and 800c both correspond to the system of the second aspect of the invention illustrated in FIG. 6a. Thus, the components used for module 800a are similar to the components used for the system described in FIG. 1a as follows: three light emitting diode (LED) arrays 801a-803a are arranged as diode light sources, where the first array 801a has diodes giving the colour red, the second array 802a has diodes giving the colour green, and the third array 803a has diodes giving the colour blue. In front of each LED array 801a-803a is arranged a polarizing filter 804-806, with each polarizing filter being arranged in front of or attached to a liquid circuit display (LCD) 807-809. The three LCD's, 807-809, are arranged on three sides of a cross dichroic prism 810, with a projection lens 811 being arranged in front of a fourth side of the prism 810. The prism 810 combines the three colour images modulated by the three LCD's 807-809, to form a colour image being projected by the lens 811. In FIG. 8a is also shown a projection screen 812 on which the image is being projected.

The components used for modules 800b and 800c are similar to the components used for the system described in FIG. 6a and are as follows: a single colour diode light source 822a or 823a, a beam splitter 814 coated to reflect UV or low wavelength blue light, a UV or low wavelength blue light source 813a, a polarizing filter 824, 825, a liquid crystal display (LCD) 826, 827, and a projection lens 828, 829. To add ultra violet or low wavelength blue light to the module, the beam splitter 814 is used. The discussion given above for UV or low wavelength blue light emitting diodes and in connection with the beam splitter 114 of FIG. 6a is naturally also valid for the UV or low wavelength blue light source and the beam splitter 814 of modules 800b, 800c. In a preferred embodiment the single colour diode light source 823a is a high wavelength blue colour diode light source, but it is also within an embodiment of the invention that it is a green colour diode light source 822a, and for the illustrated embodiment it is an array of light emitting diodes, but a single light emitting diode may also be used.

FIG. 8b shows a projection illumination system according to a second embodiment of the fourth aspect of the invention. The system of FIG. 8b comprises three projection modules 800aa, 800bb, 800cc, where each module has diode light sources and a projection lens, with the projection lenses being arranged or optical aligned in a row so as to project light on the same projection screen 812.

The module 800aa is the same as module 800a in FIG. 8a, while modules 800bb, 800cc are different to modules 800b and 800c in FIG. 8a in that there is no UV or low wavelength blue light source in modules 800bb and 800cc. The components used for modules 800bb and 800cc are as follows: a single colour diode light source 822a or 823a, a polarizing filter 824, 825, a liquid crystal display (LCD) 826, 827, and a projection lens 828, 829. In a preferred embodiment the single colour diode light source 823a is a blue colour diode light source or a green colour diode light source 822a, and for the illustrated embodiment it is an array of light emitting diodes, but a single light emitting diode may also be used.

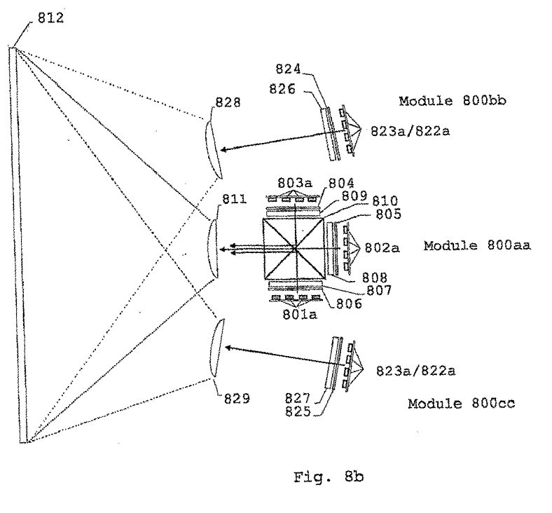

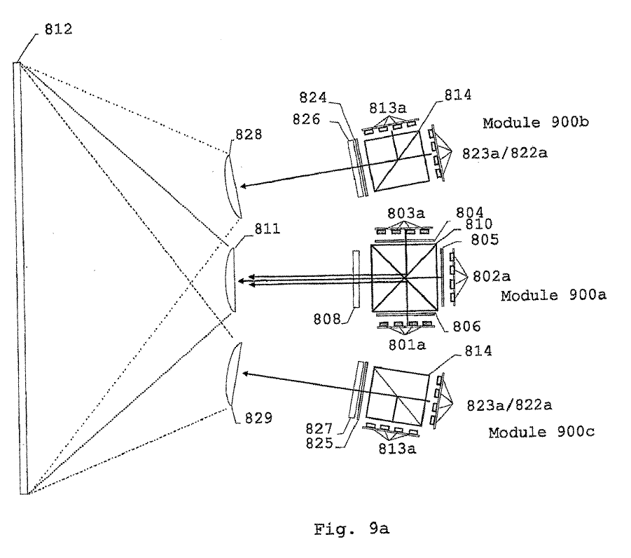

FIG. 9a shows a projection illumination system according to a third embodiment of the fourth aspect of the invention. The system of FIG. 9a also comprises three projection modules, 900a, 900b, 900c, where each module has diode light sources and a projection lens, with the projection lenses being arranged or optical aligned in a row so as to project light on the same projection screen 812.

The module 900a corresponds to a simplified version of the module 800a in FIG. 8a, and the components used for module 900a are as follows: three light emitting diode (LED) arrays 801a-803a are arranged as diode light sources, where the first array 801a has diodes giving the colour red, the second array 802a has diodes giving the colour green, and the third array 803a has diodes giving the colour blue. In front of each LED array 801a-803a is arranged a polarizing filter 804-806. A cross dichroic prism 810 directs the light from the three diode light sources 801a-803a through the LCD 808, whereby a modulated colour image is formed and being projected by the lens 811. In FIG. 9a is also shown a projection screen 812 on which the image is being projected. For the system of FIG. 9a the modules 900b and 900c are the same as modules 800b and 800c in FIG. 8a, respectively.

FIG. 9b shows a projection illumination system according to a fourth embodiment of the fourth aspect of the invention. The system of FIG. 9b also comprises three projection modules, 900aa, 900bb, 900cc, where each module has diode light sources and a projection lens, with the projection lenses being arranged or optical aligned in a row so as to project light on the same projection screen 812. The module 900aa is the same as module 900a in FIG. 9a, while modules 900bb and 900cc are the same as modules 800bb and 800cc in FIG. 8b, respectively.

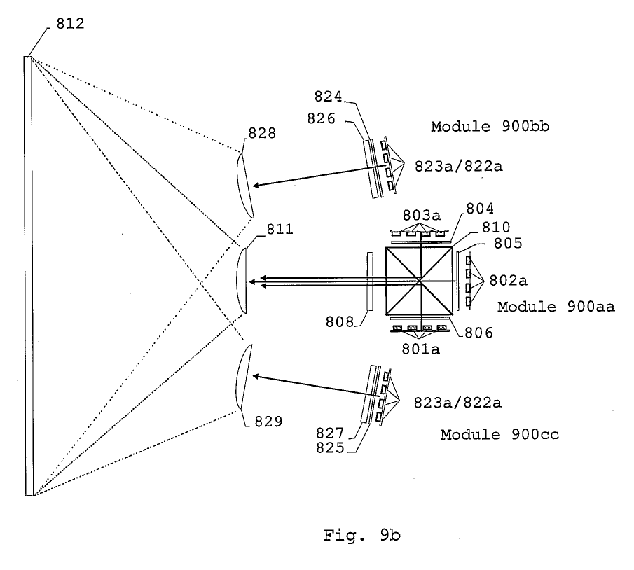

FIG. 10 shows a projection illumination system according to a fifth embodiment of the fourth aspect of the invention. The system of FIG. 10 comprises only two projection modules, 10a, 10b, where each module has diode light sources and a projection lens, with the projection lenses being arranged or optical aligned so as to project light on the same projection screen 812.

The module 10a corresponds to the system of the third aspect of the invention illustrated in FIG. 6b, while module 10b is the same as module 800b in FIG. 8a. Thus, module 10a is a combination of part of the systems according to the first aspect of the invention illustrated in FIG. 1a and part of the UV or low wavelength blue light source module illustrated in FIG. 6a, and the components used for module 10a are as follows: two light emitting diode (LED) arrays 801a-802a are arranged as diode light sources, where the first array 801a has diodes giving the colour red, the second array 802a has diodes giving the colour green; a third combined diode light source is provided and comprises a high wavelength blue colour diode light source 803a, which may be an array of LED's, a UV or low wavelength blue light emitting diode 813a and a beam splitter 814; polarizing filters 804-806 and liquid circuit displays (LCD) 807-809 are provided in front of the two diode light sources 801a, 802a and the combined diode light source; and the three LCD's, 807-809, are arranged on three sides of a cross dichroic prism 810, with a projection lens 811 being arranged in front of a fourth side of the prism 810. The discussion given above in connection with the system and components of FIG. 6b is also valid for the components of module 10a.

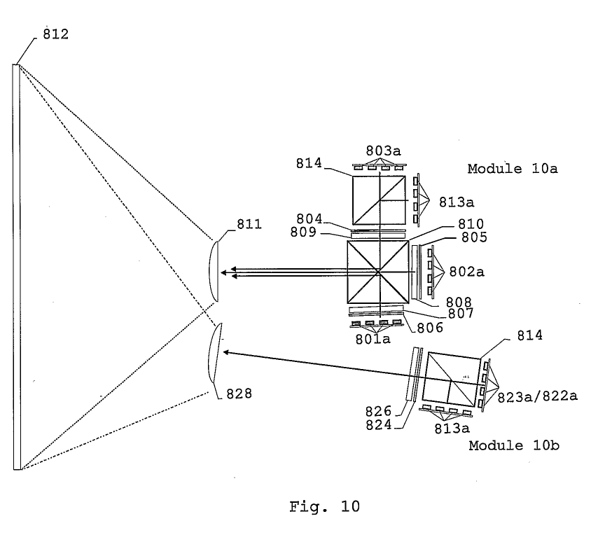

FIG. 11 shows a projection illumination system according to a sixth embodiment of the fourth aspect of the invention. The system of FIG. 11 also comprises two projection modules, 11a, 11b, where each module has diode light sources and a projection lens, with the projection lenses being arranged or optical aligned so as to project light on the same projection screen 812.

The module 11a corresponds to a simplified version of the module 10a in FIG. 10, while module 11b is the same as module 10b, which again is the same as module 800b in FIG. 8a. The components used for module 11a are as follows: two light emitting diode (LED) arrays 801a-802a are arranged as diode light sources, where the first array 801a has diodes giving the colour red, the second array 802a has diodes giving the colour green; a third combined diode light source is provided and comprises a high wavelength blue colour diode light source 803a, which may be an array of LED's, a UV or low wavelength blue light emitting diode 813a and a beam splitter 814; polarizing filters 804-806 are provided in front of the two diode light sources 801a, 802a and the combined diode light source, which filters 804-806 are arranged on three sides of a cross dichroic prism 810, with a liquid circuit displays (LCD) 808 and a projection lens 811 being arranged in front of a fourth side of the prism 810. Furthermore, then for module 11a, a filter glass 830 is inserted between the output side of the combined diode light source and the prism 810. The use of the filter glass 830 is optional, but it may be used depending on the type of LED arrays, which are used in the system. The purpose of the filter is to smooth out and redirect the light produced by the LED's on to the optical axis, thereby removing rings of light, which may be generated by various LED types. It should be noticed, that the arrangement of a filter glass 830 in front of a diode light source or a combined diode light source may also be used for the other modules or systems of the present invention.

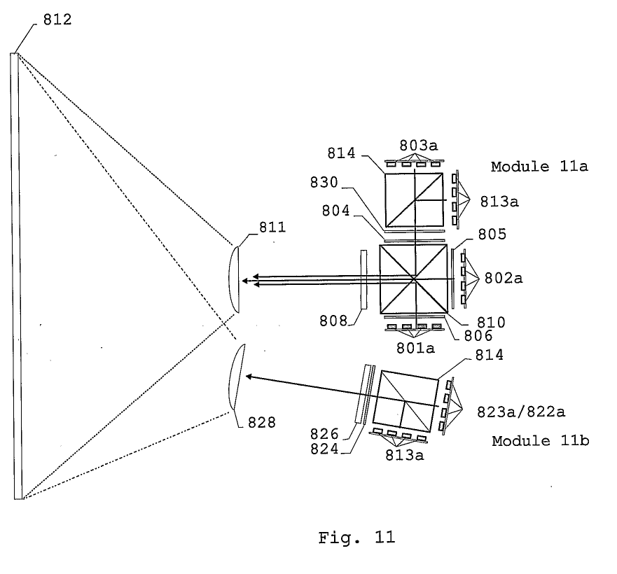

FIG. 12 shows a projection illumination system according to a seventh embodiment of the fourth aspect of the invention. The system of FIG. 12 comprises three projection modules, 12a, 12b, 12c, where each module has diode light sources and a projection lens, with the projection lenses being arranged or optical aligned in a row so as to project light on the same projection screen 812. The module 12a is similar to module 900b in FIG. 9a, while modules 12b and 12c are similar to module 900a in FIG. 9a. When comparing module 12a to module 900b and modules 12b and 12c to module 900a, some of the reference numerals have been changed. Thus, for module 12a a blue diode light source 823a is used, and the polarizing filter has reference numeral 805, the LCD has numeral 808 and the projection lens has reference numeral 811. For module 12b, the LCD has numeral 826 and the projection lens has reference numeral 828, while for module 12c, the LCD has numeral 827 and the projection lens has reference numeral 829.

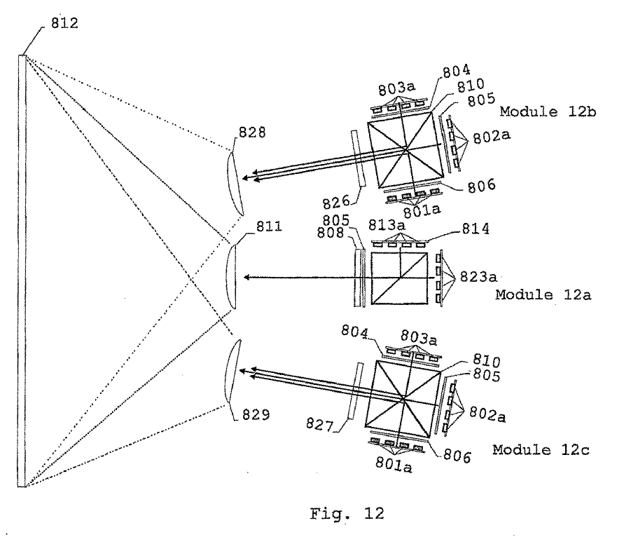

FIG. 13 shows a projection illumination system according to an eight embodiment of the fourth aspect of the invention. The system of FIG. 13 also comprises three projection modules, 13a, 13b, 13c, where each module has diode light sources and a projection lens, with the projection lenses being arranged or optical aligned in a row so as to project light on the same projection screen 812. The module 13a is similar to and has the same reference numerals as module 12a in FIG. 12, while modules 13b and 13c are similar to module 11a in FIG. 11. When comparing modules 13b and 13c to module 11a, some of the reference numerals have been changed. For module 13b, the LCD has numeral 826 and the projection lens has reference numeral 828, while for module 13c, the LCD has numeral 827 and the projection lens has reference numeral 829.

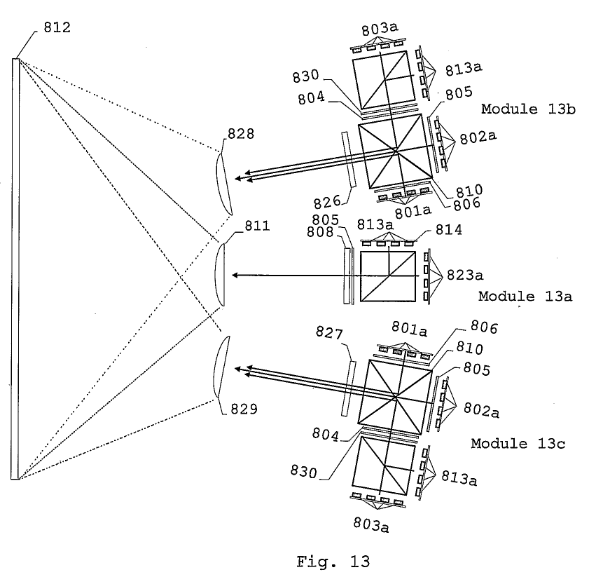

FIG. 14 shows a projection illumination system according to a ninth embodiment of the fourth aspect of the invention. The system of FIG. 14 also comprises three projection modules, 14a, 14b, 14c, where each module has diode light sources and a projection lens, with the projection lenses being arranged or optical aligned in a row so as to project light on the same projection screen 812. The module 14a is similar to module 800bb in FIG. 8b, while modules 14b and 14c are similar to modules 12b and 12c, respectively, of FIG. 12. When comparing module 14a to module 800bb some of the reference numerals have been changed, and for module 14a a blue diode light source 823a is used, and the polarizing filter has reference numeral 805, the LCD has numeral 808 and the projection lens has reference numeral 811.

It should be understood that for the modules and systems described in connection with FIGS. 8a, 8b, 9a, 9b and 10-14, the light emitting diodes, diode arrays or single LED diodes discussed above for use in the systems of FIGS. 1a and 1b may be used. In the same way, the polarizing filters, liquid crystal displays, prism and projection lens discussed above for use in the systems of FIG. 1a and 1b may be used in the systems of FIGS. 8a, 8b, 9a, 9b and 10-14. Also the power supply circuitry an the circuitry for controlling image modulation of the LCD's illustrated and discussed above in connection with FIGS. 2 and 5 for use in the systems of FIGS. 1a and 1b may be used in the systems of FIGS. 8a, 8b, 9a, 9b and 10-14. For the systems of the fourth aspect of the invention having projection modules including a UV or low wavelength blue light source, then the discussion given above in connection with the UV or low wavelength blue light emitting diodes, the beam splitter 114 and the prism 110 of FIGS. 6a, 6b and 6c is naturally also valid for the UV or low wavelength blue light source and the beam splitter 814 and prism 810 of these modules.

In order to obtain an optimal displayed video quality by a “three lens” projector using the principles of the fourth aspect of the invention and having three projection modules and thereby three projection lenses, the relative position of the projection modules and thereby the projection lenses must be adjusted and fine-tuned. The following parameters may have an influence on the adjustment and fine-tuning process: Selected picture size and distance from apparatus to projection screen or canvas.

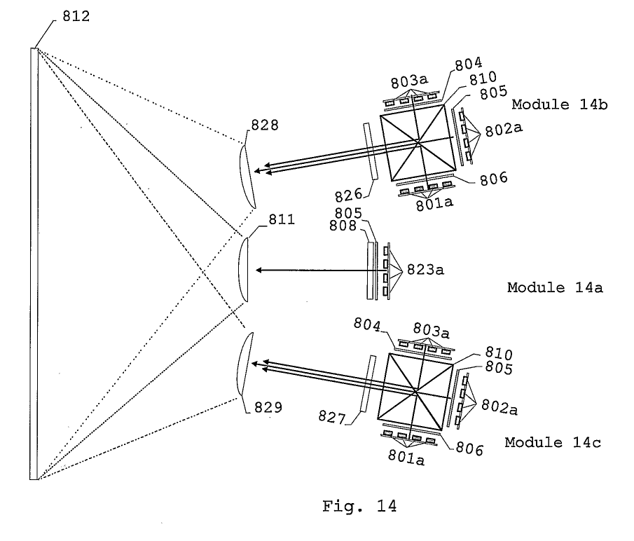

The optical adjustment of a three lens projector corresponding to the projection illumination system shown in FIG. 8a is illustrated in FIG. 15, which shows a projection system having a centre projection module A, a right projection module B, and a left projection module C. The three lens projector must be situated in the chosen distance to a projection screen or canvas, with the projection lenses front facing the canvas. The centre projection module, A, is turned on and the position of the centre module A is adjusted up or down in order to obtain the desired position of the projected picture (for example 1.5 meter from floor to bottom of picture). A test picture with grid may be displayed in order to help with the next adjustment steps described below.

The right projection module B is now adjusted so that the centre point of the picture displayed by module B is substantially on top of the centre point of the picture generated by the centre module A. This is achieved by moving the module B right/left and/or up/down into position. Finally the position of module B may be locked with securing bolts.

The left projection module C is also adjusted so that the centre point of the picture displayed by module C is substantially on top of the centre point of the picture generated by the centre module A. This is achieved by moving the module C right/left and/or up/down into position. Finally the position of module C may be locked with securing bolts.

For the above-described adjustment of the projection modules, it is the whole module including the projection lens that is adjusted. However, the lenses may be hold in a fixed position during this adjustment, while the remaining part of the projection module is adjusted. As the adjustment is left/right and up/down, the distance between the LCD's and the projection lens of a module is kept substantially constant during such an adjustment.

The adjustment and final tuning of the projector should be carried out either manually or automatically. However, it is preferred that the projector leaves the assembly line with pre-adjusted and fine-tuned settings (Fore example: 50″ picture size, with a distance of 2 meters from apparatus to canvas).

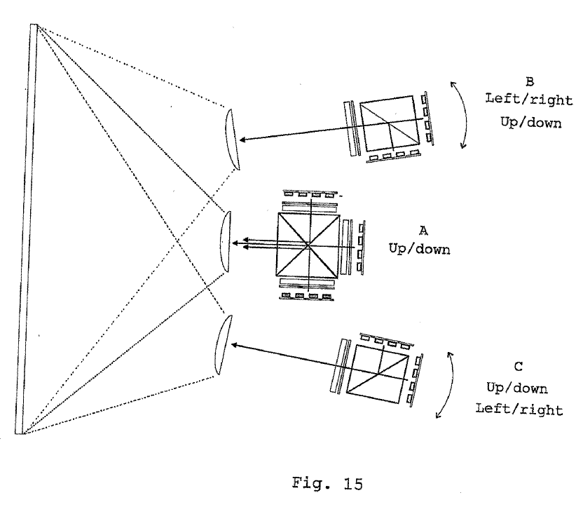

FIG. 16 is a front view schematically illustrating a first embodiment of movement directions of projection lenses used for the optical alignment of the projection illumination system shown in FIG. 15. In FIG. 16, the lenses B, A, C are secured to a frame of the projector. Optical alignment of the lenses B, A, C may be achieved by adjusting the securing bolts of the lenses. Centre lens A is aligned up/down, right and left lenses B, C are aligned up/down and left/right. However, optical alignment should preferably be preformed on production assembly line.

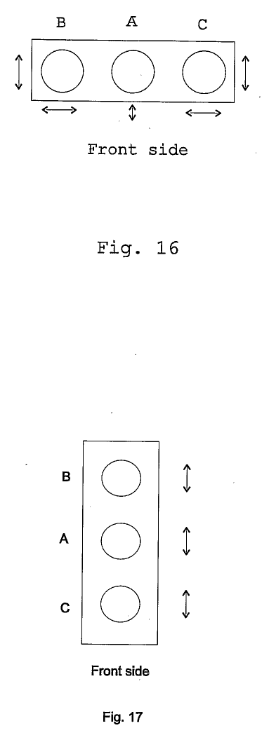

FIG. 17 is a front view schematically illustrating a second embodiment of movement directions of projection lenses, when the apparatus is situated up right (vertical), used for the optical alignment of the projection illumination system shown in FIG. 15. In FIG. 17, the lenses B, A, C are secured to a frame of the projector. Optical alignment of the lenses B, A, C may be achieved by adjusting the securing bolts of the lenses. Centre lens A and lenses B, C are aligned up/down. However, optical alignment should preferably be performed on production assembly line.

Since projecting at an angle causes distortion, it may necessary to fine-tune the position of the LCD's of projection modules B and C in FIG. 15. This may be achieved through use of digital keystone either manually or automatically through an integrated sensor system that may compensate for any distortion. Thus, using digital keystone, the displayed pictures from all LCD's in the projector must come together substantially or exactly on top of each other on the canvas.

Today most portable devices such as Cellular Telephones, PDA and Ipods etc. have a small standard 1″-2″ LCD display from which a user can read text, control menus and programs etc. However, the small size LCD displays in cellular telephones and small size portable equipment, in general, are unattractive for people to look at for long periods of time. People tend to get tired in their eyes and may get headache from watching a small LCD display for a long time. In addition, the broadband technology in cellular telephones and small size portable equipment today, makes it possible for consumers to enter video conferencing, downloading video or watching video directly from the Internet. This means that consumers, in the near future, for example will be able to surf on the Internet or watch a movie on their cellular telephone. Consequently, there is a need for an alternative way of displaying video/data on cellular telephones and small size portable equipment.

An illumination system according to one or more embodiments of the first and third aspects of the present invention may be used for providing an ultra small size image or video projector, which may be built into several types and sizes of portable equipment, thereby creating the possibility of displaying video or images from an ultra small projector within a cellular telephone, laptop, Ipaq, Ipod, portable devise etc. on to a canvas or white wall. Such an ultra small projector may be placed in the side, front side, backside, top, or bottom of the housing of the cellular telephone or portable devise. The light from the projector may be reflected inside a portable devise through an adjustable up and down mirror. As an example, when using an illumination system using the single diode LED's of the above-described example, then an acceptable quality of a projected image in the size of 32″ has been achieved on a canvas.

A small size image or video projector using an illumination system of the present invention may also be applied and put to use in several kinds of furniture, buildings, housing etc. For example the projector can be built into at table sofa, or a wall in a bedroom. In addition, such small size projectors can be clustered, meaning that several of the projectors can be situated on top of each other, around each other in a square or in a 365 degrees circle. Thus, displaying an image in up to 7 dimensions or more, giving an appearance of a holographic screen.

A “three lens” projector using the principles of the fourth aspect of the invention may be used to provide an inexpensive home cinema alternative to existing plasma/TFT/DLP screens and DLP/LCD/CTR projectors. The three lens projector apparatus may have several advantages: The projector can be produced relatively small in size. When compared to a plasma/TFT screen, which is very visible in a living room and takes a lot of space, the three lens projector will not be very visible in the room when turned off. The three lens projector can be placed on a table or mounted in the ceiling. In addition, since the three lens projector has a low power consumption and generates a low level of heat, the projector may be built into various types of furniture or a wall. The three lens projector will also have a very long lamp live of 10.000 to 20.000 hours.

It should be understood that various modifications may be made to the above-described embodiments and it is desired to include all such modifications and functional equivalents as fall within the scope of the accompanying claims.

1. An illumination system comprising:
at least three diode light sources including a red, a green and a blue diode light source, with at least one of the light sources being an array of light emitting diodes,
at least three polarizing light converting elements corresponding to each colour of diode light sources, and
at least one prism arrangement, characterized in that the illumination system further comprises
at least three liquid crystal panels corresponding to each colour of diode light sources, and
a filter glass,
wherein red diode light is directed through a first polarizing light converting element and a first liquid crystal panel into a first side of the prism arrangement, green diode light is directed through a second polarizing light converting element and a second liquid crystal panel into a second side of the prism arrangement, and blue diode light is directed through a third polarizing light converting element and a third liquid crystal panel into a third side of the prism arrangement,
wherein the filter glass is arranged in front of an array of light emitting diodes and between the array of light emitting diodes and the corresponding polarizing light converting element, and
wherein the prism arrangement is adapted to reflect or emit the polarized light received at the first, second and third prism sides in a single direction throughout a fourth side being an exit plane of the prism.

2. An illumination system according to claim 1, wherein at least two of the light sources are arrays of light emitting diodes, and wherein for each of said diode arrays a filter glass is arranged in front of the diode array and between the diode array and the corresponding polarizing light converting element.

3. An illumination system according to claim 1, wherein at least one or each light source comprises an array of light emitting diodes, with each array holding a plurality of light emitting diodes of similar colour.

4. An illumination system according to claim 3, wherein for each of said diode arrays a filter glass is arranged in front the diode array and between the diode array and the corresponding polarizing light converting element.

5. An illumination system according to claim 1, further comprising a projection lens, and wherein the prism arrangement is adapted to reflect or emit the polarized light received at the first, second and third prism sides in a single direction throughout the fourth side of the prism and through the projection lens.

6. An illumination system according to claim 1, wherein the first liquid crystal panel is arranged parallel to the first prism side, the second liquid crystal panel is arranged parallel to the second prism side, and the third liquid crystal panel is arranged parallel to the third prism side.

7. An illumination system according to claim 1, wherein the first polarizing light element is arranged parallel to the first liquid crystal panel, the second polarizing light element is arranged parallel to the second liquid crystal panel, and the third polarizing light element is arranged parallel to third liquid crystal panel.

8. An illumination system according to claim 1, further comprising circuitry for controlling each liquid crystal panel as a function of an image or video input signal, whereby the polarized light received at the first, second and third prism sides represents three colour modulated versions of the same image, said three image versions being modulated by polarized red, green and blue light, respectively.

9. An illumination system according to claim 8, wherein the first, second and third liquid crystal panels are arranged or aligned relatively to each other so that the light reflected by the prism throughout the exit plane of the prism represents a colour image being a combination of the received three colour modulated image versions.

10. An illumination system according to claim 1, further comprising power supply circuitry for supplying power to each light source, said power supply circuitry being adapted for an individual control or adjustment of the power delivered to the light sources.

11. A light source module comprising:
at least a first diode light source providing blue diode light in the visible range,
at least a second light source, and
a beam splitter arranged to emit light received from the first diode light source and light received from the second light source, characterized in that
the second light source comprises an UV (ultra-violet) diode light source or a low wavelength blue diode light source in the wavelength range of 410-455 nm.

12. A light source module according to claim 11, wherein the beam splitter is arranged to emit light received from the first light source and light received from the second light source in a direction throughout a single exit plane of the beam splitter or reflection system.

13. A light source module according to claim 11, wherein the light from the first and second light sources received by the beam splitter is emitted from the beam splitter in a single direction or along a single optical axis.

14. A light source module according to claim 11, further comprising a polarizing light element, and wherein the light from the first and second light sources emitted by the beam splitter system is directed through said polarizing light element.

15. A light source module according to claim 11, further comprising a liquid crystal panel, and wherein the light from the first and second light sources being emitted by the beam splitter is directed through said liquid crystal panel.

16. A light source module according to claim 11, further comprising a polarizing light element and a liquid crystal panel, wherein the light from the first and second light sources being emitted by the beam splitter is directed through the polarizing light element and the liquid crystal panel.

17. A light source module according to claim 16, further comprising a projection lens or lens system, and wherein the light being directed through the liquid crystal panel is further directed through the projection lens or lens system.

18. An illumination system comprising:
a plurality of diode light modules, and
a prism arrangement surrounded by the plurality of diode light modules and arranged so as to emit a combination of lights received from the plurality of light modules, characterized in that
at least one of said plurality of light modules is a UV or low wavelength blue light module comprising
a first light source having a UV (ultra-violet) diode light source or a low wavelength blue diode light source in the wavelength range of 410-455 nm,
a second light source with a visible blue diode light source, and
a beam splitter arranged to emit light received from the first and second light sources.

19. An illumination system according to claim 18, wherein the beam splitter is arranged to emit light received from the first and second light sources in a direction throughout a single exit plane of the beam splitter.

20. An illumination system according to claim 18, wherein the prism arrangement comprises a cubical prism.

21. An illumination system according to claim 18, wherein the prism arrangement comprises a dichroic prism or a cross dichroic prism.

22. An illumination system according to claim 20, wherein the prism has a first side, a second side, a third side and a fourth side, and wherein the plurality of light modules comprises three modules with a first module emitting light into the first side of the prism, a second module emitting light into the second side of the prism, and a third module emitting light into the third side of the prism, and
wherein the prism arrangement is adapted to emit the combination of lights received at the first, second and third prism sides in a single direction throughout the fourth side of the prism.

23. An illumination system according to claim 18, wherein the plurality of light modules further comprises a red light module with a red diode and/or laser light source and a green light module with a green diode light source.

24. An illumination system according to claim 22, wherein the plurality of light modules further comprises a red light module with a red diode and/or laser light source and a green light module with a green diode light source, and wherein the first light module is the red light module, the second light module is the green light module and the third light module is the UV or low wavelength blue light module.

25. An illumination system according to claim 18, wherein each light module comprises a corresponding polarizing light element.

26. An illumination system according to claim 25, wherein for each light module the emitted light is directed through the corresponding polarizing light element and into the prism arrangement.

27. An illumination system according to claim 18, wherein each light module comprises a corresponding liquid crystal panel.

28. An illumination system according to claim 26, wherein each light module comprises a corresponding liquid crystal panel, and wherein for each light module the emitted light is directed through the corresponding polarizing light element and the corresponding liquid crystal panel and into the prism arrangement.

29. An illumination system according to claim 18, wherein a liquid crystal panel or element is arranged on a light outgoing side of the prism arrangement.

30. An illumination system according to claim 18, wherein a Digital Light Processing unit, an optical lens and a second prism are arranged on a light outgoing side of the prism arrangement so that the outgoing light from the prism arrangement is directed through the optical lens and reflected by the second prism as light input to the Digital Light Processing unit.

31. An illumination system according to claim 30, further comprising a projections lens or outgoing lens system, and wherein the second prism and the Digital Light Processing unit are arranged so and so that light output from the Digital Light Processing unit is transmitted through the second prism and directed through the projection lens or outgoing lens system.

32. An illumination system according to claim 18, further comprising a projection lens or lens system, and wherein the light being emitted from the prism arrangement is further directed through said projection lens or lens system.

33. An illumination system according to claim 18, wherein the UV or low wavelength blue light source comprises a UV light emitting diode.

34. An illumination system according to claim 18, wherein part of or each of the light source modules comprise an array of light emitting diodes, with each array holding a plurality of light emitting diodes of similar colour.

35. An illumination system according to claim 18, wherein part of or each of the light source modules comprise a laser or a laser diode.

36. An illumination system according to claim 25, wherein each light module comprises a corresponding liquid crystal panel, and wherein the illumination system further comprises circuitry for controlling each liquid crystal panel as a function of an image or video input signal, whereby the polarized light received by the prism arrangement represents three colour modulated versions of the same image.

37. An illumination system according to claim 36, wherein the system has a first, second and third liquid crystal panel, which are arranged or aligned relatively to each other so that the light emitted by the prism arrangement represents a colour image being a combination of the received three colour modulated image versions.

38. An illumination system according to claim 18, further comprising power supply circuitry for supplying power to each light modules, said power supply circuitry being adapted for an individual control or adjustment of the power delivered to the light modules.
